(19) United States
(12) Patent Application Publication
(10) Pub. No.: US 2026/0009686 A1
(43) Pub. Date: Jan. 8, 2026

(54) SYSTEM AND METHOD FOR ULTRASONIC WELD CONDUCTOR ALIGNMENT

(71) Applicant: Becton, Dickinson and Company, Franklin Lakes, NJ (US)

(72) Inventors: John Randolph Dewing, Costa Mesa, CA (US); Matthew Nelson Brown, Fountain Valley, CA (US); Graham Alan Jacobs, Laguna Niguel, CA (US); Markus George Grauer, Ladera Ranch, CA (US)

(21) Appl. No.: 19/328,076

(22) Filed: Sep. 12, 2025

Related U.S. Application Data
(63) Continuation of application No. PCT/US2024/019183, filed on Mar. 8, 2024.
(60) Provisional application No. 63/489,911, filed on Mar. 13, 2023.

(51) Int. Cl. G01L 19/00; H01R 4/02; H01R 43/02

(52) U.S. Cl. CPC G01L 19/0061; H01R 43/0207; H01R 4/023

(57) ABSTRACT

A wire housing assembly includes a housing and a wire. The housing includes a first swaging groove and a second swaging groove. A wire is excised such that a plurality of signal conductors are exposed, and rest within the first swaging groove and the second swaging groove. A wire jacket extends from a signal conductor to a first excise point. An additional portion of the wire jacket extends from a second excise point to the end of the housing. A cavity in the housing contains the additional portion of the wire jacket. The signal conductors are anchored in between the first excise point and the second excise point. The signal conductors are swaged into place by melting the first swaging groove and the second swaging groove via an ultrasonic welder. A sensor may then contact the signal conductors.

### CROSS-REFERENCE TO RELATED APPLICATIONS

This application is a continuation of International Application No. PCT/US2024/019183, filed March 8, 2024, and entitled “SYSTEM AND METHOD FOR ULTRASONIC WELD CONDUCTOR ALIGNMENT,” which claims the benefit of U.S. Provisional Application No. 63/489,911, filed March 13, 2023, and entitled “SYSTEM AND METHOD FOR ULTRASONIC WELD CONDUCTOR ALIGNMENT,” the disclosures of which are hereby incorporated by reference in their entirety.

### BACKGROUND

Wire swaging can be done by resting a wire on a material, such as plastic, and melting the material. The wire is then encompassed by the material and held in place as the material cools. A wire may become misaligned during this process due to a disturbance or any number of external forces. In such a case, the wire will remain misaligned after the material cools and the wire is held in place. Thus, a system for ensuring alignment through the swaging process is desirable.

### SUMMARY

A wire housing assembly includes a housing connecting end, a housing terminating end, a first swaging groove, a second swaging groove, and a wire jacket housing section. The first swaging groove positioned between the housing connecting end and the housing terminating end. The first swaging groove is configured to contact one or more signal conductors. The second swaging groove positioned between the first swaging groove and the housing terminating end. The second swaging groove is configured to contact the one or more signal conductors. The wire jacket housing section positioned between the second swaging groove and the housing terminating end. The wire jacket housing section is configured to house a portion of a wire jacket that surrounds the one or more signal conductors.

A method for swaging a wire into a wire housing assembly includes excising a wire jacket of the wire to expose a plurality of signal conductors. The wire comprises a terminating end and a connecting end, wherein the terminating end terminates at an end of a housing and the connecting end connects to a signal connector. The wire jacket is excised such that the wire jacket extends from the connecting end to a first wire excise point and the wire jacket comprises a portion of wire jacket material extending from a second wire jacket excise point to the terminating end. The method further includes placing the plurality of signal conductors in contact with a first swaging groove in the housing and a second swaging groove in the housing, and swaging the wire by melting the first swaging groove and melting the second swaging groove such that the plurality of signal conductors are anchored within the housing.

### BRIEF DESCRIPTION OF THE DRAWINGS

FIG. 1 is a perspective view of a differential pressure transducer (DPT) system for monitoring fluid pressures.

FIG. 2 is a perspective view of the structural wire housing pre-swaging.

FIG. 3 is a perspective view of the structural wire housing post-swaging.

FIG. 4 is a perspective view of a differential pressure sensor connected to a plurality of signal conductors within the structural wire housing.

FIG. 5 is a flowchart detailing the steps for a method of wire swaging.

### DETAILED DESCRIPTION

According to the techniques of this disclosure, a wire housing assembly can undergo wire swaging techniques to anchor signal conductors within the wire housing assembly. Doing so allows for signal conductors to be positioned such that the signal conductors can contact a mating device including contact pins, such as a differential pressure sensor. Further according to the techniques of this disclosure, the wire housing assembly can be shaped to accommodate an end portion of a wire jacket such that the signal conductors are stabilized during the wire swaging process. This ensures that the signal conductors will remain in a correct alignment and hence the signal conductors can appropriately contact the mating device.

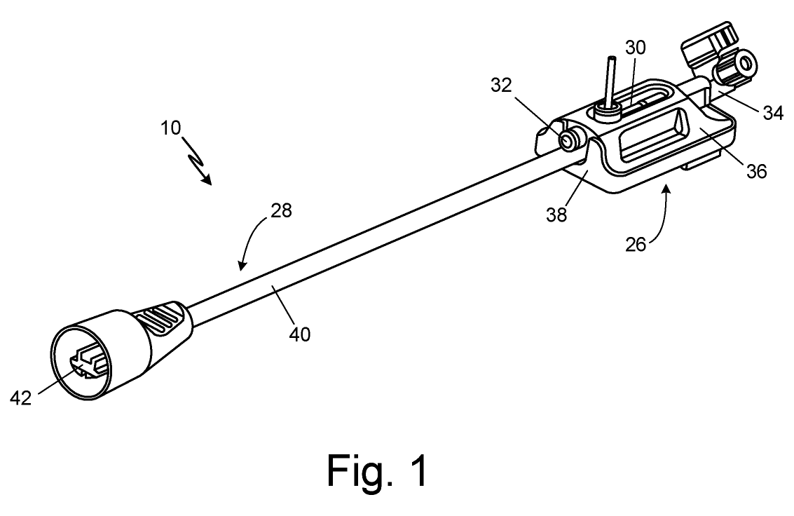

FIG. 1 is a perspective view of differential pressure transducer (DPT) system 10 for monitoring fluid pressures. DPT system 10 includes DPT sub-assembly 26 and hybrid connector 28. DPT sub-assembly 26 includes flowpath element 30 (with upstream attachment 32), stopcock 34, front cover 36, and rear cover 38. Hybrid connector 28 includes connector cable 40 and signal connector 42.

DPT sub-assembly 26 conveys intravenous (IV) fluid and generates corresponding digital and analog differential pressure signals. Hybrid connector 28 conveys both sets of signals to a connected device configured to receive the digital or analog signals, or to a device capable of receiving both. In some examples, DPT system 10 may be a factory-sterilized, single-use kit. In the most general case, however, at least DPT sub-assembly 26 is sterilized prior to use.

DPT sub-assembly 26 is a multi-sensor fluid handling device configured to receive IV fluid from a fluid source, and deliver that IV fluid to a patient IV, e.g. via a needle or shunt, through stopcock 34. Flowpath element 30 of DPT sub-assembly 26 is a rigid body defining a fluid channel through DPT sub-assembly 26. Sensors within DPT sub-assembly 26 are disposed adjacent to one another and in fluid communication with the interior of flowpath element 30 to sense differential pressure therein.

An upstream end of flowpath element 30 includes upstream attachment 32 to form a fluidically sealed connection with a fluid line from a fluid source. A downstream end of flowpath element 30 terminates at stopcock 34. Stopcock 34 is disposed downstream of sensor elements within DPT sub-assembly 26, and is a valve capable of halting fluid egress from DPT sub-assembly 26.

Flowpath element 30 and other components of DPT sub-assembly 26 are enclosed between front cover 36 and rear cover 38. Front and rear covers 36 and 38 cooperate to form necessary fluid seals, secure connector cables, and support sensor elements. Front and rear covers 36 and 38 also define the form factor of DPT sub-assembly 26 into which most other components, including multiple sensors, fit.

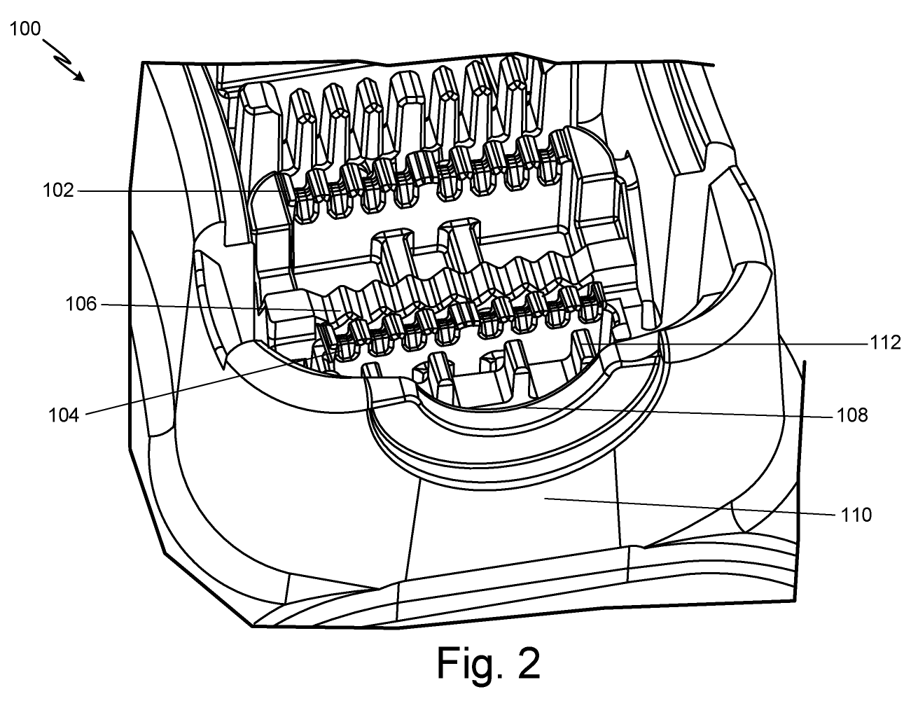

FIG. 2 is a perspective view of structural wire housing 100, which is disposed within DPT sub-assembly 26 (shown in FIG. 1), before swaging of signal conductors of a wire. Structural wire housing 100 includes first swaging grooves 102, second swaging grooves 104, support grooves 106, wire jacket housing section 108, structural wire housing terminating end 110, and wire jacket housing grooves 112.

First swaging grooves 102 are positioned on the side of structural wire housing 100 that is nearest to connector cable 40 of FIG. 1. Second swaging grooves 104 are positioned on the side of structural wire housing 100 nearest to the structural wire housing terminating end 110. Support grooves 106 are shown between first swaging grooves 102 and second swaging grooves 104 in this example. In other examples, support grooves 106 may be positioned outside first swaging grooves 102 such that support grooves 106 are closest to connector cable 40. In still other examples, support grooves 106 can be positioned outside second swaging grooves 104 such that support grooves 106 are closest to structural wire housing terminating end 110. Wire jacket housing grooves 112 are positioned adjacent to structural wire housing terminating end 110 such that there is a gap between wire jacket housing grooves 112 and structural wire housing terminating end 110 that can house a portion of a wire jacket.

In operation, a wire comprising a wire jacket and a plurality of exposed signal conductors can be placed into structural wire housing 100. The wire can be placed such that the exposed signal conductors are in contact with support grooves 106. The exposed signal conductors can also rest within first swaging grooves 102 and second swaging grooves 104. The number of swaging grooves may vary. In some examples, there may be one, two, or more than two swaging grooves. The wire jacket can be excised such that a portion of the wire jacket is configured to fit within wire jacket housing section 108, between wire jacket housing grooves 112 and structural wire housing terminating end 110. The remainder of the wire jacket can extend from first swaging grooves 102 in the direction of connector cable 40.

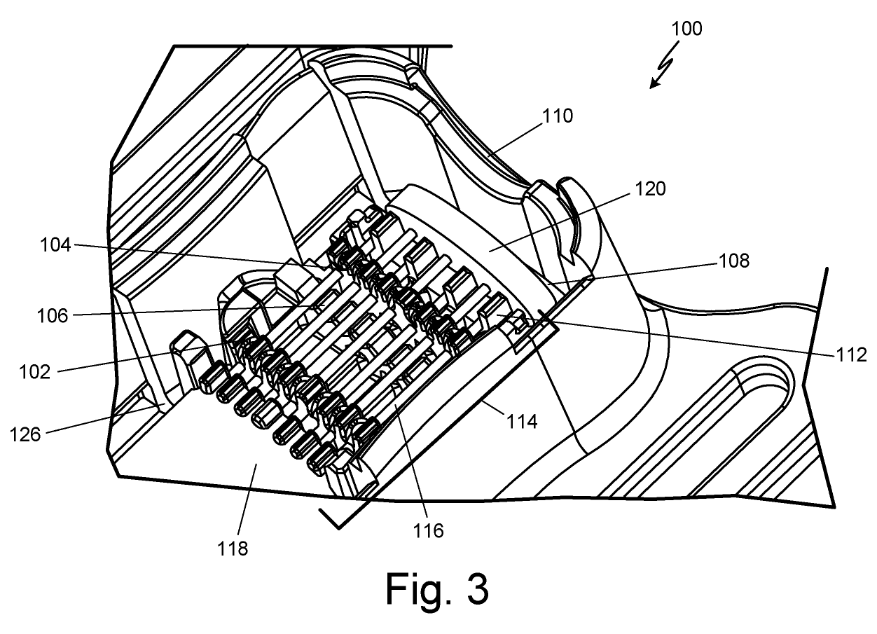

FIG. 3 is a perspective view of structural wire housing 100 after swaging. Structural wire housing 100 is disposed within DPT sub-assembly 26, and between front cover 36 and rear cover 38 of the DPT system 10 of FIG. 1. Structural wire housing 100 includes first swaging grooves 102, second swaging grooves 104, support grooves 106, wire jacket housing section 108, structural wire housing terminating end 110, structural wire housing connecting end 126, and wire jacket housing grooves 112. Additionally, wire 114 rests within structural wire housing 100. Wire 114 includes signal conductors 116, connecting end wire jacket 118, and terminating end wire jacket portion 120.

As described in FIG. 2, first swaging grooves 102 are positioned on the side of structural wire housing 100 that is nearest to structural wire housing connecting end 126 and connector cable 40 of FIG. 1. Second swaging grooves 104 are positioned on the side of structural wire housing 100 nearest to the structural wire housing terminating end 110. Support grooves 106 are shown between first swaging grooves 102 and second swaging grooves 104 in this example. In other examples, support grooves 106 may be positioned outside first swaging grooves 102 such that support grooves 106 are closest to connector cable 40. In still other examples, support grooves 106 can be positioned outside second swaging grooves 104 such that support grooves 106 are closest to structural wire housing terminating end 110.

Wire 114 is positioned such that signal conductors 116 rest within support grooves 106. Signal conductors 116 are also positioned such that signal conductors 116 are within first swaging grooves 102 and second swaging grooves 104. Signal conductors may also be positioned within wire jacket housing grooves 112. Connecting end wire jacket 118 encases signal conductors 116 and extends toward connector cable 40 of FIG. 1. Terminating end wire jacket portion 120 encases signal conductors 116, and is positioned within wire jacket housing section 108. Wire jacket housing section 108 is configured such that terminating end wire jacket portion 120 fits between structural wire housing terminating end 110 and wire jacket housing grooves 112.

Signal conductors 116 are initially placed within first swaging grooves 102 and second swaging grooves 104, and are then swaged into place. Swaging occurs via an ultrasonic welder which melts the material of first swaging grooves 102 and second swaging grooves 104. Signal conductors 116 are then enveloped by the melted material of first swaging grooves 102 and the melted material of second swaging grooves 104 as the melted material reflows around signal conductors 116. After the material cools, signal conductors 116 are fixed in their respective positions.

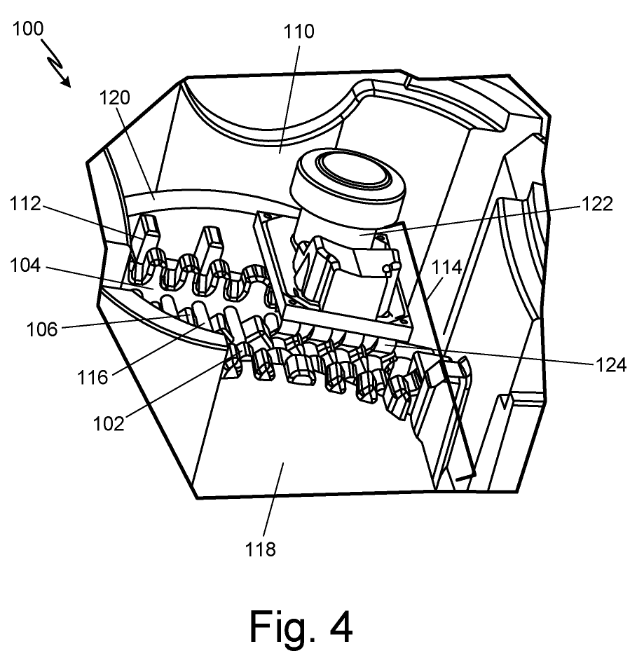

The configuration of structural wire housing 100 of FIG. 3 provides the advantage of keeping signal conductors 116 in alignment through the swaging process. Signal conductors 116 are supported by connecting end wire jacket 118 and terminating end wire jacket portion 120. As such, signal conductors 116 can remain aligned throughout the swaging process despite disturbances caused by bumps or other external forces. Without the support of connecting end wire jacket 118 and terminating end wire jacket portion 120, signal conductors 116 may become misaligned during the swaging process. The alignment of signal conductors 116 can facilitate the connection of a sensor, or other device including contact pins, as depicted in FIG. 4. The misalignment of signal conductors 116 can prevent the connection of a sensor and render the DPT assembly unusable. Thus, the alignment of signal conductors 116 is advantageous to the operation of the whole DPT system.

FIG. 4 is a perspective view of structural wire housing 100 with sensor 122 attached. Structural wire housing 100 is disposed within DPT sub-assembly 26, and between front cover 36 and rear cover 38 of the DPT system 10 of FIG. 1. Structural wire housing 100 includes first swaging grooves 102, second swaging grooves 104, support grooves 106, wire jacket housing section 108, structural wire housing terminating end 110, and wire jacket housing grooves 112. Structural wire housing 100 further includes wire 114. Wire 114 includes signal conductors 116, connecting end wire jacket 118, and terminating end wire jacket portion 120. Structural wire housing 100 also includes sensor 122, wherein sensor 122 includes sensor contact pins 124.

FIG.4 differs from FIGS. 2 and 3 in that sensor 122 is connected to signal conductors 116 via sensor contact pins 124. In the depiction of FIG.4, sensor contact pins 124 connect sensor 122 to signal conductors 116 at support grooves 106, however sensor contact pins 124 may contact signal conductors 116 at any point at which signal conductors 116 are exposed. In some examples, sensor 122 is a differential pressure sensor. In other examples, sensor 122 can be any type of sensor or other device configured to receive information from signal conductors 116. There may also be multiple sensors in addition to sensor 122, wherein the additional sensors also contact signal conductors 116. In one example, sensor 122 is an analog pressure sensor and an additional second sensor is a digital pressure sensor. In other examples, there may be one, two, or more than two sensors configured to contact signal conductors 116 via sensor contact pins 124.

Sensor contact pins 124 are electrically isolated spring clips disposed in parallel and extending from their respective sensors to each respective conductor. More generally, sensor contact pins 124 are separate electrical contacts between respective conductors and sensors. Sensor 122 may contact signal conductors 116 via sensor contact pins 124 such that a longitudinal axis of signal conductors 116 extends in a perpendicular direction with respect to sensor 122.

Signal conductors 116 are configured to carry the sensed pressure from sensor 122 to one or more signal connectors. The one or more signal connectors can then transmit the sensed pressure to one or more patient monitors. In some examples, signal conductors 116 are configured to carry an analog signal. In other examples, signal conductors 116 are configured to carry a digital signal. In still other examples, some signal conductors are configured to carry an analog signal while others are configured to carry a digital signal based on the pressure sensor attached.

The configuration described in FIG. 4 provides advantages similar to those described in FIG. 3. As depicted in FIG. 4, sensor 122 connects to signal conductors 116 via sensor contact pins 124. Thus, it is necessary for the alignment of the signal conductors to hold throughout the swaging process such that sensor contact pins 124 can align with signal conductors 116 such that sensor 122 is able to connect and receive data.

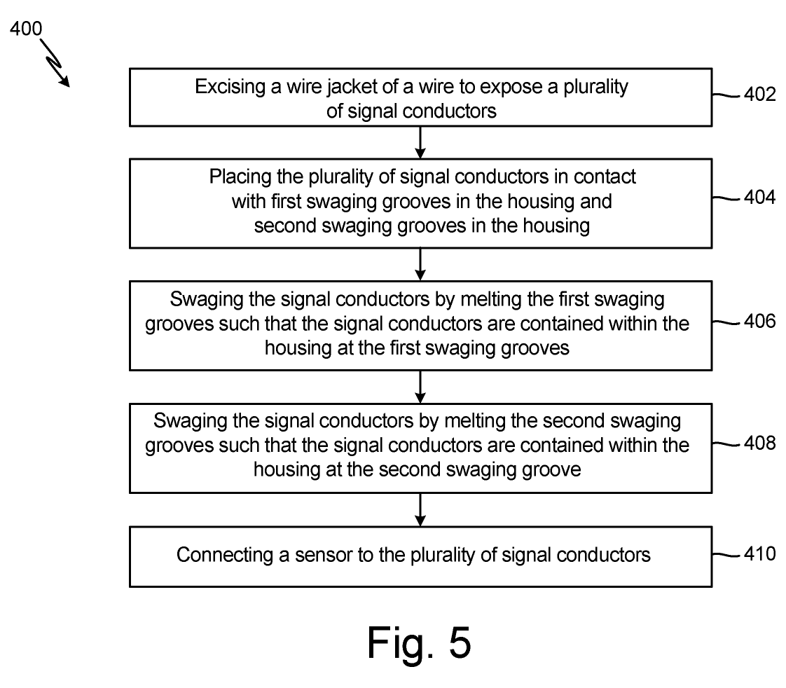

FIG. 5 is a flowchart detailing the steps for wire swaging method 400. For the purposes of illustration, representative part numbers from structural wire housing 100 of FIG. 4 will be included in the description of wire swaging method 400.

At step 402, the wire jacket of wire 114 is excised such that signal conductors 116 are exposed. Wire 114 may be excised to create connecting end wire jacket 118 and terminating end wire jacket portion 120. At step 404, signal conductors 116 are placed in contact with first swaging grooves 102 and second swaging grooves 104 within structural wire housing 100. Signal conductors 116 may also be placed in contact with support grooves 106. At step 406, signal conductors 116 are swaged into place by melting first swaging grooves 102 such that signal conductors 116 are contained within first swaging grooves 102. At step 408, signal conductors 116 are swaged into place by melting second swaging grooves 104 such that signal conductors 116 are contained within second swaging grooves 104. At steps 406 and 408, melting first swaging grooves 102 and second swaging grooves 104 may be done by an ultrasonic welder. At step 410, sensor 122 is connected to signal conductors 116. At step 410, sensor 122 can be connected via sensor contact pins 124.

As described in this disclosure, a wire comprising a wire jacket and signal conductors can be swaged into place within a wire housing while minimizing the chances of signal conductor misalignment. The techniques of this disclosure accomplish this benefit by stabilizing the signal conductors at a connecting end, where a wire jacket extends to a signal connector, and at a terminating end, where a portion of the wire jacket rests within the sensor housing. After the signal conductors are swaged into place, a sensor can contact the signal conductors via sensor contact pins, and data can be communicated.

Any of the various systems, devices, apparatuses, etc. in this disclosure can be sterilized (e.g., with heat, radiation, ethylene oxide, hydrogen peroxide, etc.) to ensure they are safe for use with patients, and the methods herein can comprise sterilization of the associated system, device, apparatus, etc. (e.g., with heat, radiation, ethylene oxide, hydrogen peroxide, etc.).

### DISCUSSION OF DETAILED EMBODIMENTS

The following are non-exclusive descriptions of possible embodiments of the present invention.

A wire housing assembly includes a housing connecting end, a housing terminating end, a first swaging groove, a second swaging groove, and a wire jacket housing section. The first swaging groove positioned between the housing connecting end and the housing terminating end. The first swaging groove is configured to contact one or more signal conductors. The second swaging groove positioned between the first swaging groove and the housing terminating end. The second swaging groove is configured to contact the one or more signal conductors. The wire jacket housing section positioned between the second swaging groove and the housing terminating end. The wire jacket housing section is configured to house a portion of a wire jacket that surrounds the one or more signal conductors.

The wire housing assembly of the preceding paragraph can optionally include, additionally and/or alternatively, any one or more of the following features, configurations and/or additional components:

A further embodiment of the foregoing wire housing assembly, wherein the wire housing assembly is sterilized.

A further embodiment of any of the foregoing wire housing assemblies, further comprising a differential pressure sensor electrically connected to the one or more signal conductors.

A further embodiment of any of the foregoing wire housing assemblies wherein the one or more signal conductors are disposed to carry signals from the differential pressure sensor to one or more monitors.

A further embodiment of any of the foregoing wire housing assemblies, wherein the differential pressure sensor is connected perpendicular to a longitudinal direction of the one or more signal conductors.

A further embodiment of any of the foregoing wire housing assemblies, further comprising a plurality of support grooves.

A further embodiment of any of the foregoing wire housing assemblies, wherein the one or more signal conductors rest within the plurality of support grooves.

A further embodiment of any of the foregoing wire housing assemblies, wherein the differential pressure sensor contacts the one or more signal conductors at a point where the signal conductors rest within the plurality of support grooves.

A further embodiment of any of the foregoing wire housing assemblies, wherein the housing contains a housing cavity at a housing terminating end, wherein the housing terminating end is adjacent to the wire jacket terminating end.

A further embodiment of any of the foregoing wire housing assemblies, wherein the portion of wire jacket material at the terminating end of the wire jacket rests within the housing cavity.

A further embodiment of any of the foregoing wire housing assemblies, wherein the first swaging groove is configured to be melted to swage the one or more signal conductors to the housing.

A further embodiment of any of the foregoing wire housing assemblies, wherein the second swaging groove is configured to be melted to swage the one or more signal conductors to the housing.

A further embodiment of any of the foregoing wire housing assemblies further including a wire. The wire includes a wire terminating end and a wire connecting end. The wire terminating end is positioned at the housing terminating end, and the wire connecting end extends to a signal conductor connection point. The wire jacket extends from the signal conductor connection point to a first wire jacket excise point. The wire jacket comprises a portion of wire jacket material extending from a second wire jacket excise point to the wire terminating end. The one or more signal conductors are in contact with the first swaging groove between the first wire jacket excise point and the second wire jacket excise point. The one or more signal conductors are in contact with the second swaging groove between the first wire jacket excise point and the second wire jacket excise point.

A method for swaging a wire into a wire housing assembly includes excising a wire jacket of the wire to expose a plurality of signal conductors. The wire comprises a terminating end and a connecting end, wherein the terminating end terminates at an end of a housing and the connecting end connects to a signal connector. The wire jacket is excised such that the wire jacket extends from the connecting end to a first wire excise point and the wire jacket comprises a portion of wire jacket material extending from a second wire jacket excise point to the terminating end. The method further includes placing the plurality of signal conductors in contact with a first swaging groove in the housing and a second swaging groove in the housing, and swaging the wire by melting the first swaging groove and melting the second swaging groove such that the plurality of signal conductors are anchored within the housing.

A further embodiment of the foregoing method, wherein the wire housing assembly is sterilized.

A further embodiment of any of the foregoing methods, further comprising connecting a differential pressure sensor to the plurality of signal conductors.

A further embodiment of any of the foregoing methods, wherein the plurality of signal conductors are disposed to carry signals from the differential pressure sensor to one or more monitors.

A further embodiment of any of the foregoing methods, wherein the differential pressure sensor is connected perpendicular to a longitudinal direction of the plurality of signal conductors.

A further embodiment of any of the foregoing methods, wherein the housing further comprises a plurality of support grooves.

A further embodiment of any of the foregoing methods, further comprising placing the plurality of signal conductors within the plurality of support grooves.

A further embodiment of any of the foregoing methods, wherein the differential pressure sensor contacts the plurality of signal conductors at a point where the signal conductors rest within the plurality of support grooves.

A further embodiment of any of the foregoing methods, wherein the housing contains a housing cavity at a housing terminating end, wherein the housing terminating end is adjacent to the wire jacket terminating end.

A further embodiment of any of the foregoing methods, wherein the portion of wire jacket material at the terminating end of the wire jacket rests within the housing cavity

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A wire housing assembly comprising:
a housing connecting end and a housing terminating end;
a first swaging groove positioned between the housing connecting end and the housing terminating end, wherein the first swaging groove is configured to contact one or more signal conductors;
a second swaging groove positioned between the first swaging groove and the housing terminating end, wherein the second swaging groove is configured to contact the one or more signal conductors; and
a wire jacket housing section positioned between the second swaging groove and the housing terminating end, wherein the wire jacket housing section is configured to house a portion of a wire jacket that surrounds the one or more signal conductors.

2. The wire housing assembly of claim 1, wherein the wire housing assembly is sterilized.

3. The wire housing assembly of claim 1, further comprising a differential pressure sensor electrically connected to the one or more signal conductors.

4. The wire housing assembly of claim 3, wherein the one or more signal conductors are disposed to carry signals from the differential pressure sensor to one or more monitors.

5. The wire housing assembly of claim 3, wherein the differential pressure sensor is connected perpendicular to a longitudinal direction of the one or more signal conductors.

6. The wire housing assembly of claim 3, further comprising a plurality of support grooves positioned between the housing connecting end and the housing terminating end.

7. The wire housing assembly of claim 6, wherein the one or more signal conductors rest within the plurality of support grooves.

8. The wire housing assembly of claim 7, wherein the differential pressure sensor contacts the one or more signal conductors at a point where the one or more signal conductors rest within the plurality of support grooves.

9. The wire housing assembly of claim 1, wherein the first swaging groove is configured to be melted to swage the one or more signal conductors to the first swaging groove.

10. The wire housing assembly of claim 1, wherein the second swaging groove is configured to be melted to swage the one or more signal conductors to the second swaging groove.

11. The wire housing assembly of claim 1, further comprising a wire including a wire jacket and a plurality of signal conductors, wherein:
the wire comprises a wire terminating end and a wire connecting end, wherein the wire terminating end is positioned at the housing terminating end, and the wire connecting end extends to a signal conductor connection point;
the wire jacket extends from the signal conductor connection point to a first wire jacket excise point;
the wire jacket comprises a portion of wire jacket material extending from a second wire jacket excise point to the wire terminating end;
the one or more signal conductors are in contact with the first swaging groove between the first wire jacket excise point and the second wire jacket excise point; and
the one or more signal conductors are in contact with the second swaging groove between the first wire jacket excise point and the second wire jacket excise point.

12. A method for swaging a wire into a wire housing assembly, the method comprising:
excising a wire jacket of the wire to expose a plurality of signal conductors, wherein:
the wire comprises a terminating end and a connecting end, wherein the terminating end terminates at an end of a housing and the connecting end connects to a signal connector;
the wire jacket is excised such that the wire jacket extends from the connecting end to a first wire excise point and the wire jacket comprises a portion of wire jacket material extending from a second wire jacket excise point to the terminating end;
placing the plurality of signal conductors in contact with a first swaging groove in the housing and a second swaging groove in the housing; and
swaging the wire by melting the first swaging groove and melting the second swaging groove such that the plurality of signal conductors are anchored within the housing.

13. The method of claim 12, wherein the wire housing assembly is sterilized.

14. The method of claim 12, further comprising connecting a differential pressure sensor to the plurality of signal conductors.

15. The method of claim 14, wherein the plurality of signal conductors are disposed to carry signals from the differential pressure sensor to one or more monitors.

16. The method of claim 14, wherein the differential pressure sensor is connected perpendicular to a longitudinal direction of the plurality of signal conductors.

17. The method of claim 14, wherein the housing further comprises a plurality of support grooves.

18. The method of claim 17, further comprising placing the plurality of signal conductors within the plurality of support grooves.

19. The method of claim 18, wherein the differential pressure sensor contacts the plurality of signal conductors at a point where the signal conductors rest within the plurality of support grooves.

20. The method of claim 12, wherein the housing contains a housing cavity at a housing terminating end, wherein the housing terminating end is adjacent to the terminating end of the wire.
